(19) United States
(12) Patent Application Publication
(10) Pub. No.: US 2024/0386752 A1
(43) Pub. Date: Nov. 21, 2024

(54) System And Method For Monitoring Timing Events in Games, Practices, Training, and/or Recruiting Events

(71) Applicant: John Alden Gee, Eagle Mountain, UT (US)

(72) Inventor: John Alden Gee, Eagle Mountain, UT (US)

(21) Appl. No.: 18/197,637

(22) Filed: May 15, 2023

(51) Int. Cl. G07C 1/22

(52) U.S. Cl. CPC G07C 1/22

(57) ABSTRACT

A method for players, coaches, referees, trainers, recruiters and/or spectators to keep track of critical timing events and/or time between events of a game, practice, training, and/or recruiting event. The method uses a non-mechanical means to trigger one or more timing events through the use of a sensor such as but not limited to infrared, ultrasonic, time of flight, and/or lidar.

### BACKGROUND OF THE INVENTION

Many games, practices, training, and/or recruiting events require maintaining consistent timing of events as well as timing between events. Referees, coaches, players, trainers, recruiters and/or spectators have difficulty knowing and/or maintaining the appropriate timing of events and/or time between events. These difficulties can cause much anxiety, stress, unfairness and frustration between referees, coaches, players, trainers, recruiters and/or spectators.

### SUMMARY OF THE INVENTION

This system and method helps referees, coaches, players, trainers, recruiters and/or spectators to easily know and/or maintain the appropriate timing of events and/or time between events. In addition it helps relieve the anxiety, stress, unfairness and frustration of referees, coaches, players, trainers, recruiters and/or spectators by alerting people of the events and/or timing between events.

### BRIEF DESCRIPTION OF DRAWINGS

Drawing Descriptions as Follows:

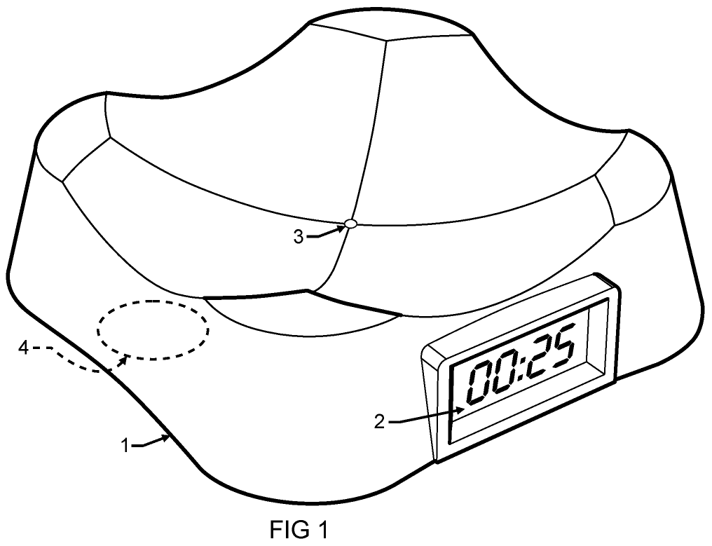

a. FIG. 1 depicts an example of the invention base unit (1). This example includes a clock (2) to show a visual representation of the timing. It also depicts a trigger (3) for an event and/or an event timing. Also in this example, is an audio device (4) to alert referees, coaches, players, trainers, recruiters and/or spectators of timing events or time between events.

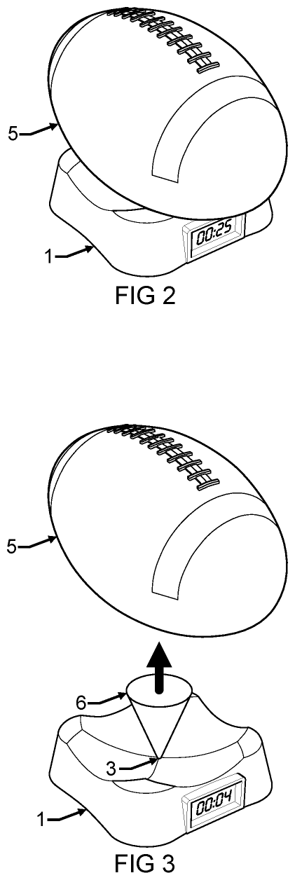

b. FIG. 2 depicts an object (5) sitting on the base unit (1) of the invention.

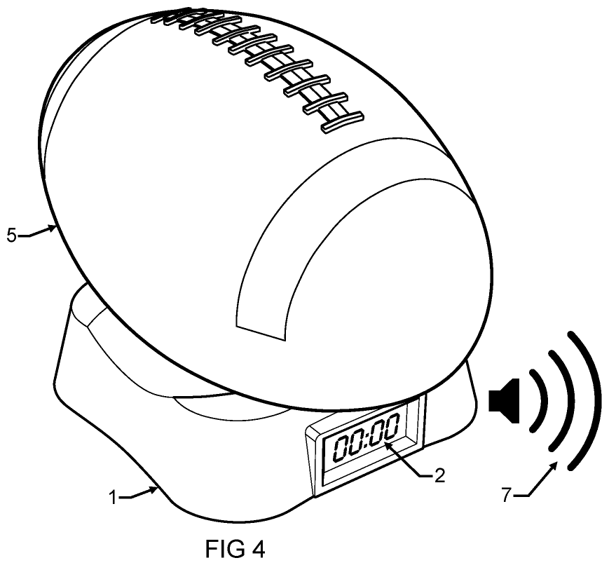

c. FIG. 3 depicts an object (5) lifted from the base unit (1) of the invention. It also depicts the trigger detection zone (6) above the trigger (3).

d. FIG. 4 shows an object (5) sitting on the base unit (1) of the invention. It also depicts a clock (2) as well as a representation of the audio alert (7) heard from the invention.

### DETAILED DESCRIPTION OF THE INVENTION

The invention consists of a base unit (FIG. 1) (1) which can hold an object (FIG. 2) (5) with a method to detect whether the object has been placed on (FIG. 2) or removed from (FIG. 3) the base unit a certain distance from the detection zone (FIG. 3) (6) of the method of detection. The method of detection of the position of the object is provided by means of a sensor (FIG. 1) (3) such as but not limited to infrared, ultrasonic, time of flight, and/or lidar. The invention alerts multiple timing events through means of audio (FIG. 1) (4) and/or visual means (FIG. 1) (2) such as but not limited to how long the object has been placed on the base unit to indicate the length of time between events as well as how long the object has been removed from the base unit to indicate time taken during an event.

1. A device with the ability to trigger more than one timing event when an object has been placed and/or removed from it through the use of a non mechanical trigger mechanism.
